(19) United States
(12) Patent Application Publication
(10) Pub. No.: US 2025/0238518 A1
(43) Pub. Date: Jul. 24, 2025

(54) PRIORITIZED RISK MITIGATION IN TRANSACTION SEQUENCES

(71) Applicant: Cisco Technology, Inc., San Jose, CA (US)

(72) Inventors: Jaideep Padhye, San Jose, CA (US); Tom JOSE, Sunnyvale, CA (US); Girish SIVASUBRAMANIAN, Mountain House, CA (US)

(21) Appl. No.: 18/417,360

(22) Filed: Jan. 19, 2024

(51) Int. Cl. G06Q 20/40; G06F 21/57

(52) U.S. Cl. CPC G06F 21/577; G06Q 10/0635

(57) ABSTRACT

In one implementation, a method is disclosed comprising: identifying a sequence of transactional milestones performed by users within an online application; determining individual risk assessments for each transactional milestone, based in part on any vulnerabilities associated with code used to perform those transactional milestones; determining, based on the individual risk assessments, an overall risk assessment for the sequence of transactional milestones; and providing a representation of the sequence of transactional milestones with indications of the individual risk assessments and the overall risk assessment for the sequence of transactional milestones for display by a user interface.

### TECHNICAL FIELD

The present disclosure relates generally to computer systems, and, more particularly, to prioritized risk mitigation in transaction sequences.

### BACKGROUND

Online applications are becoming increasingly complex systems that comprise many services (e.g., micro-services) hosted across a wide variety of locations. For instance, consider the case of a retail application whereby a user first logs into their account, then browses for products, adds a selected product to their cart, enters payment information, confirms their order, and then checks out, to complete the purchase. Underlying each of these transactional milestones from the standpoint of a user may be the various services associated with the retail application. For example, the user logging into their account may entail their mobile app connecting to an identity service, the checkout may entail sending their credit card information to a financial service for approval, etc.

Bad actors remain focused on taking advantage of siloed security and vulnerabilities across these distributed services, with consequences ranging from data exfiltration to complete disruption of the application, among others. Even knowing which vulnerabilities exist for a given service underlying a particular transaction, though, does little to help security personnel mitigate against such attacks, due to the often vast number of vulnerabilities that may exist across the entire application. Consequently, security personnel are often left having to triage addressing the vulnerabilities. Without any insight into the sequence of transactions supported by those services, though, it remains challenging to prioritize which vulnerabilities should be addressed first.

### BRIEF DESCRIPTION OF THE DRA WINGS

The implementations herein may be better understood by referring to the following description in conjunction with the accompanying drawings in which like reference numerals indicate identically or functionally similar elements, of which:

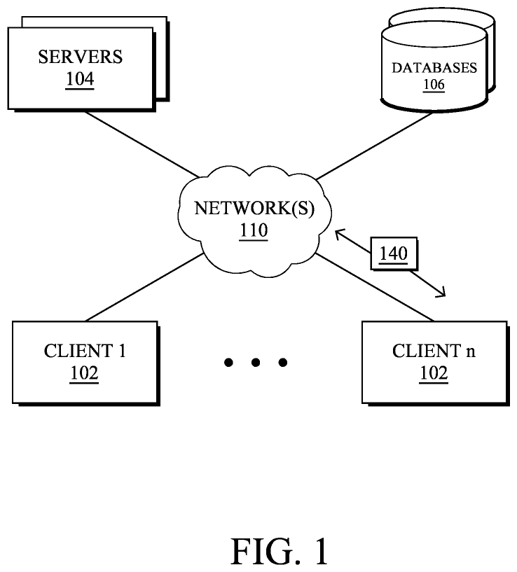

FIG. 1 illustrates an example of a computer network;

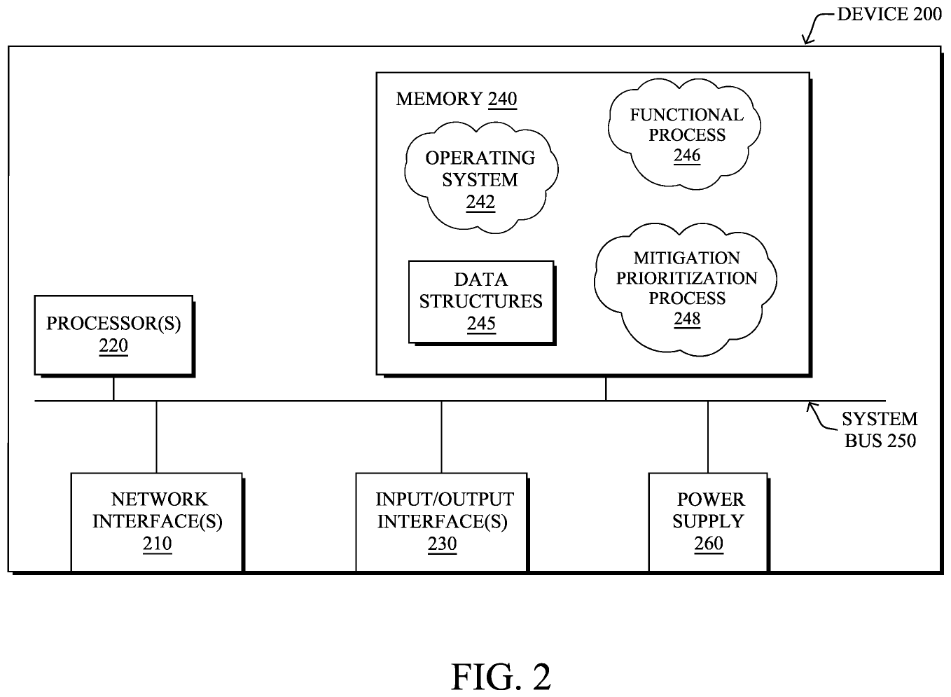

FIG. 2 illustrates an example of a computing device/node;

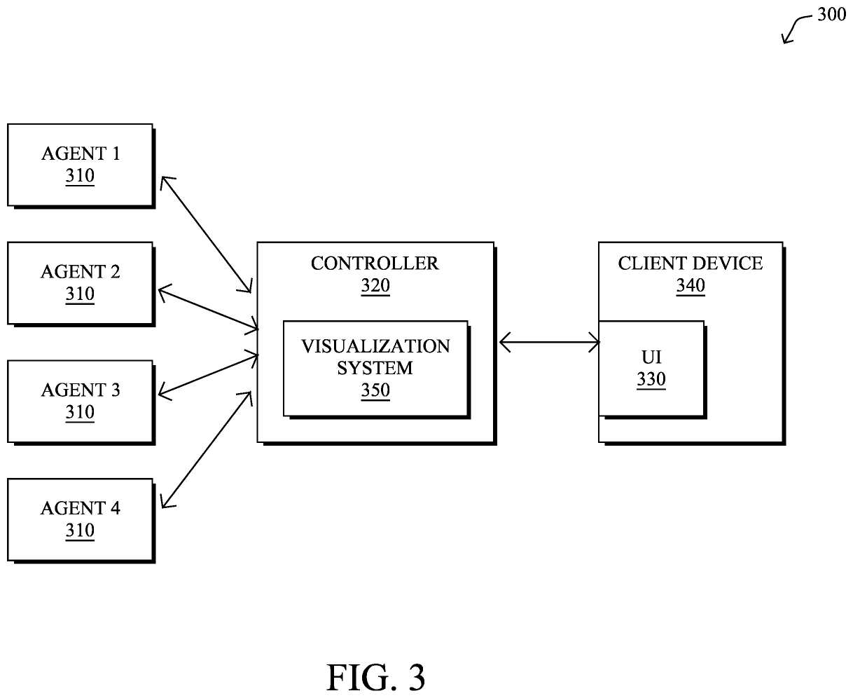

FIG. 3 illustrates an example of an observability intelligence platform;

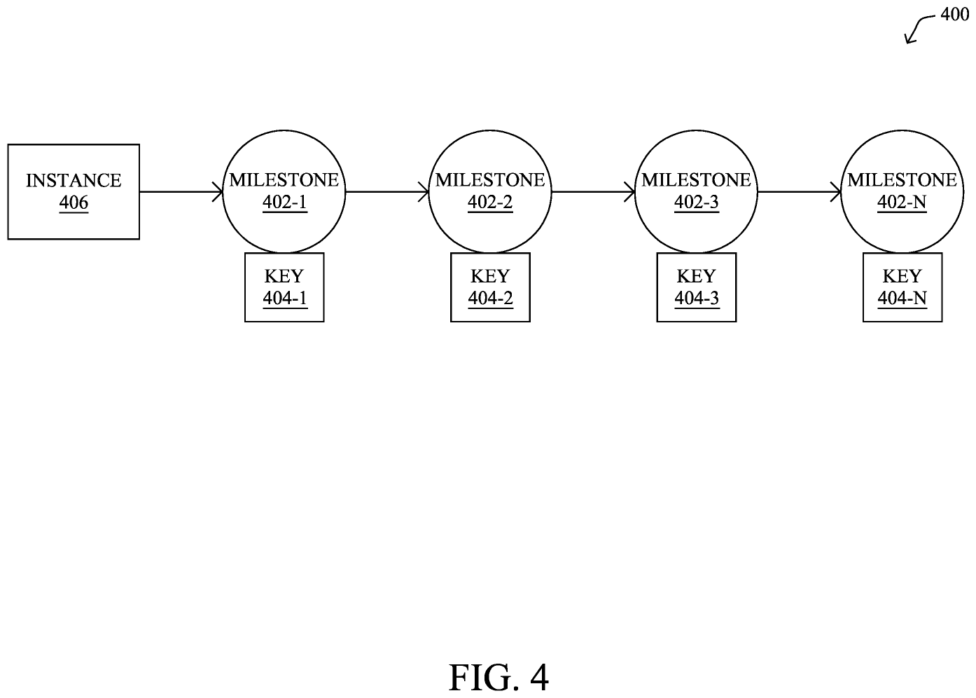

FIG. 4 illustrates an example of a sequence of transactions monitored by a key-based process monitoring platform;

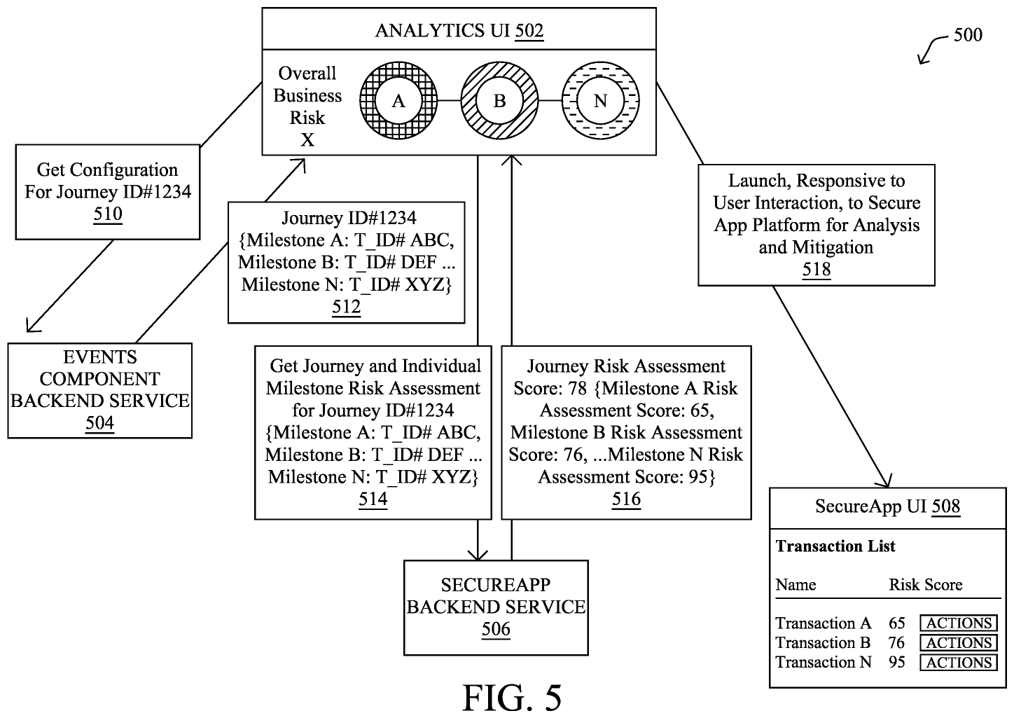

FIG. 5 illustrates an example of an architecture for prioritized risk mitigation in transaction sequences;

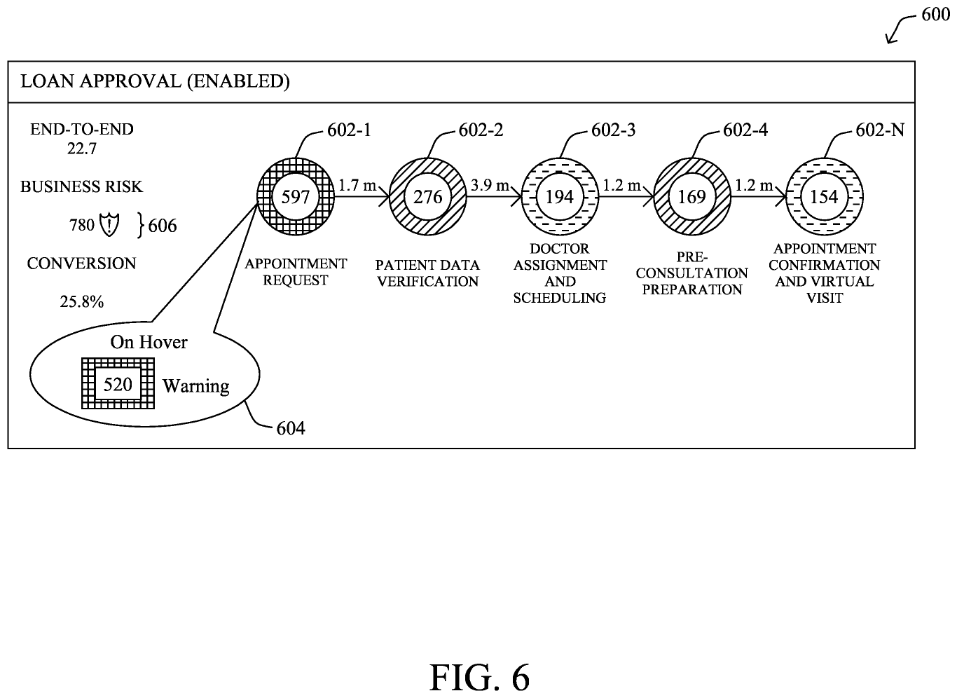

FIG. 6 illustrates an example of a graphical representation rendered by an analytics platform in prioritized risk mitigation in transaction sequences; and

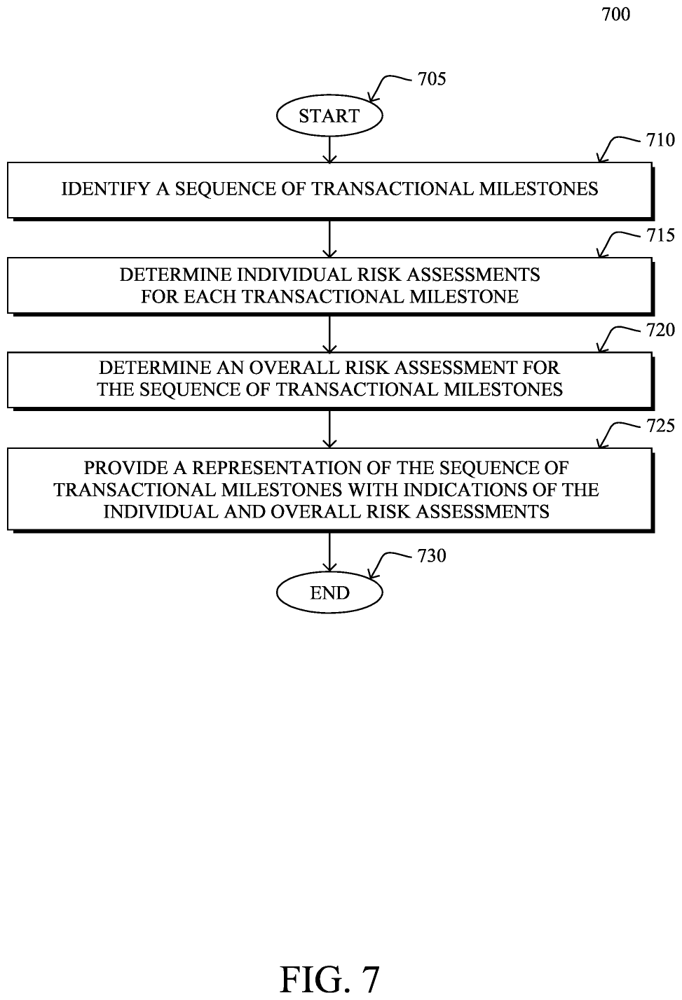

FIG. 7 illustrates an example simplified procedure prioritized risk mitigation in transaction sequences in accordance with one or more embodiments described herein.

### DESCRIPTION OF EXAMPLE EMBODIMENTS

### Overview

According to one or more implementations of the disclosure, a device may facilitate prioritized risk mitigation in business transaction sequences based on individual risk assessments for each transaction of the sequence of transactions. For example, the device may identify a sequence of transactional milestones performed by users within an online application. The device may determine individual risk assessments for each transactional milestone, based in part on any vulnerabilities associated with code used to perform those transactional milestones. Then, the device may determine, based on the individual risk assessments, an overall risk assessment for the sequence of transactional milestones. The device may provide a representation of the sequence of transactional milestones with indications of the individual risk assessments and the overall risk assessment for the sequence of transactional milestones for display by a user interface. Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102 (e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

FIG. 2 is a schematic block diagram of an example node/device 200 that may be used with one or more implementations described herein, e.g., as any of the devices 102-106 shown in FIG. 1 above. Device 200 may comprise one or more network interfaces (e.g., network interface(s) 210) (e.g., wired, wireless, etc.), at least one processor (e.g., processor(s) 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces (e.g., network interface(s) 210), e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

Memory 240 comprises a plurality of storage locations that are addressable by the processor(s) 220 and the network interface(s) 210 for storing software programs and data structures associated with the implementations described herein. The processor(s) 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more functional processes (e.g., functional processes 246), and on certain devices, an illustrative process (e.g., mitigation prioritization process 248), as described herein. Notably, functional processes 246, when executed by processor(s) 220, cause each particular device to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while the processes have been shown separately, those skilled in the art will appreciate that processes may be routines or modules within other processes.

### ——Observability Intelligence Platform——

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicates the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310) and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (e.g., interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance (e.g., controller 320) may be hosted remotely by a provider of the observability intelligence platform 300. In an illustrative on-premises (On-Prem) implementation, a controller instance may be installed locally and self-administered.

Controller 320 may receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents is generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain examples, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be implemented across multiple devices, on different devices, utilizing additional devices, and so on, and the views shown herein are merely simplified examples that are not meant to be limiting to the scope of the present disclosure.

### ——Transaction Sequences——

FIG. 4 illustrates an example of a sequence 400 of transactions monitored by a key-based process monitoring platform, in accordance with one or more implementations described herein. Sequence 400 may include a series of tasks, a set of activities, a business process, etc.

In some instances, the sequence 400 may be referred to as a journey or a business journey. This term may be used to describe a series of related business transactions that together form a complete business process. A journey may be a logical grouping instrument providing a higher-level view of performance by tracking a sequence of transactions that represent a user or system journey through an application or series of applications. For example, a journey might track a user's path from product selection, through payment, to order confirmation in an online shopping experience.

That is, sequence 400, or journey, may include an end-to-end cross-tier processing path used to fulfill a request for a service. For example, sequence 400 may involve execution of a workflow such as a transaction process whose execution spans different transactions, event types, applications, services, third-party service providers, servers, data stores, etc. Examples of sequence 400 may include an e-commerce checkout business process, a payment transfer process, a credit card approval process, a loan submission/approval process, a mobile phone service activation/recharge process, an insurance application process through policy approval, insurance claims approval process, etc.

The sequence 400 may be defined by one or more transactions. These transactions may each be an event or step in executing a business workflow. For example, a transaction may represent a workflow instance 406 of a user-initiated task that accomplishes a specific goal within an application. This could be anything from checking out a shopping cart on an e-commerce site to making a payment in a banking app. These transactions make be tracked by a key-based process monitoring platform to measure their performance and determine if they are functioning within acceptable parameters.

These transactions may be tracked and/or visualized as milestones 402 (402-1 . . . 402-N) each made up by an event or step in executing a business workflow. Each of the milestones 402 may be a sequential event marking a significant stage in a workflow. For example, in an e-commerce checkout business process, the first milestone 402-1 may be a transaction such as a user login to the e-commerce platform. The second milestone 402-2 might be a transaction such as the user adding an item listed for sale on the e-commerce platform to their cart. The third milestone 402-3 may include a transaction such as the user adding their payment information. The fourth milestone 402-N might be a transaction such as the user completing the checkout process by submitting the order and the payment information for processing by the e-commerce platform. Multiple milestones linked together may comprise an end-to-end holistic representation of the various stages of workflow execution for sequence 400; in this case purchasing an item from an e-commerce platform.

As customer demands for flawless services rise, application teams need to evaluate the success of their process holistically as well as the performance of each component. This includes monitoring and analyzing performance metrics associated with execution of each workflow in sequence 400 (e.g., by observability intelligence platform 300 of FIG. 3). Sequence 400 may include events from multiple analytics event types, such as logs, business transactions, custom events, and EUM data. In addition, these workflows can manifest over long periods of time and cannot be measured using single transaction monitoring alone. Instead, monitoring and analyzing the performance metrics for an entirety of a sequence 400 that spans multiple applications, services, events, etc. may be accomplished by correlating linear data flows across multiple event sources to track and collect metrics for each workflow instance 406 of sequence 400.

In various implementations, defining sequence 400 may involve defining a key 404 (e.g., 404-1 . . . 404-N) that spans all the milestones 402 of the sequence 400, thereby tying them together for monitoring purposes. This same key (e.g., key 404) is then shared across each of the milestones 402 and can be used as an identifier to monitor the events associated with each workflow instance 406 and their corresponding performance metrics. Therefore, the monitoring, collection, and/or analysis of performance metrics from an execution of a particular workflow instance is associated with and/or identifiable by the key 404 at each milestone.

The key 404 may be a certain type of data that is able to be identified from end-to-end of the process and typically varies from workload instance to workload instance. For example, in the previously outlined e-commerce checkout business process, a key 404 may be defined as the userID for the end user driving the workflow. The userID may represent a good candidate for key 404 as it is consistently available across milestones 402 in this example and its value is unique for each distinct user of the e-commerce platform (e.g., each user has a different userID). As such, the userID will serve as a unique key to uniquely identify each workload instance driven by a different end user of the e-commerce checkout business process.

### ——Prioritized Risk Mitigation in Transaction Sequences——

As noted above, traditional vulnerability and threat scanning solutions lack shared context and correlated insights from across the IT estate. These approaches are therefore inadequate to provide any sort of contextualized prioritization of threat mitigation and render efficient and targeted automated threat mitigation implausible, especially in circumstances where a process is executed across distributed services. In short, these approaches are not equipped to facilitate priority alignment in risk mitigation of a modern end-to-end process.

For example, existing approaches to risk identification have involved siloed risk evaluations. For example, a risk score may be assigned to an individual IT infrastructure element. While this type of scoring may be helpful with regard to analyzing that particular IT infrastructure element, it is ultimately insufficient for providing any sort of risk evaluation in the context of an end-to-end sequence of business transactions (e.g., a business journey).

Existing business process monitoring approaches are not able to monitor a workflow using a common key. Therefore, even if they had access to risk scores of the processes behind the individual business transactions, they lack a mechanism by which they can discern the relationships between different combinations of business transactions within different sequences of transactions. In fact, for a given customer there could be a large number (e.g., hundreds, thousands, etc.) of transactions that a customer wishes to monitor across multiple journeys, but the existing solutions are unable to facilitate this context.

Ascertaining the risk associated with a particular transaction under these approaches may involve manually parsing through exhaustive listings of transactions of varying relevance to locate the particular transaction and its risk information. Even once identified within such a listing, there is no way to appreciate the risk of the transaction within the context of its unique sequence of transactions making up a particular complex and/or distributed process of an application. As a result, each identified transaction would, at best, remain a data island unto itself under the current monitoring regimes. This disconnect between the risk posed by an individual transaction and its contribution to the overall risk for a particular sequence of which it is a constituent component serves as a roadblock to intelligent risk visualization and prioritization of risk mitigation.

That is, existing approaches are only able to provide risk scoring info as a disjointed list of business transactions (BTs), without any regard to the business journeys that include those transactions. So, you might see a BT in the login workflow (e.g., password, multi-factor authentication, etc.), then a BT in the checkout workflow (e.g., search, add to cart, checkout, etc.).

Different business journeys, though, may have different degrees of importance in certain circumstances. So, users not being able to log into an app at all might be very important, and it may be prudent to address the vulnerabilities associated with those BTs, first. Conversely, users not being able to update their email addresses might be less important, so it may be prudent to wait to fix those vulnerabilities.

In contrast, the techniques herein facilitate prioritized risk mitigation in the context of their applicable transaction sequences. By building an understanding of the configurations and risks of each of the transactions within a sequence and their risk relationships to a sequence, these techniques not only provide end-to-end risk analysis but also prioritize risk mitigation candidate transactions. For example, by mapping a transaction's risk assessment to corresponding process milestones and/or to an overarching sequence of transactions making up an end-to-end application process, users are empowered with visualizations and prioritization tools that can be used to prioritize risk mitigation in their processes. That is, by leveraging this advanced risk visualization and strategic mitigation approach, users are empowered to proactively manage potential threats, ensuring that resources are effectively allocated to safeguard key processes against disruptions rather than being haphazardly applied without the full context of the risk that they pose. Consequently, users can swiftly identify and address critical vulnerabilities, transforming complex data into actionable insights and substantially enhancing operational resilience.

Illustratively, the techniques described herein may be performed by hardware, software, and/or firmware, such as in accordance with mitigation prioritization process 248, which may include computer executable instructions executed by the processor(s) 220 (or independent processor of interface(s) 210) to perform functions relating to the techniques described herein.

Specifically, and according to various implementations, a device may identify a sequence of transactional milestones performed by users within an online application. The device may determine individual risk assessments for each transactional milestone, based in part on any vulnerabilities associated with code used to perform those transactional milestones. Then, the device may determine, based on the individual risk assessments, an overall risk assessment for the sequence of transactional milestones. The device may provide a representation of the sequence of transactional milestones with indications of the individual risk assessments and the overall risk assessment for the sequence of transactional milestones for display by a user interface.

Operationally, FIG. 5 illustrates an example of an architecture 500 for prioritized risk mitigation in transaction sequences. In architecture 500 a method may be implemented whereby a path is enabled for a user already monitoring the most critical processes. This path may facilitate a click-through from a risk-modified process configuration visualization to a threat identification/mitigation visualization featuring prioritized mitigation candidate transactions that are risk contributors to the particular critical process being analyzed in the risk-modified application performance monitoring platform visualization.

Architecture 500 may include and/or be integrated with an analytics component and/or a secure application component of an application performance monitoring platform. For example, architecture 500 may be incorporated within suite of tools that allows for the collection, monitoring, and analysis of data to provide insights into application performance and user behavior. The analytics component may aggregate and visualize metrics, logs, and other data to help understand how well an application is functioning. This analytics component might include user experience monitoring, application diagnostics, and performance trend analysis. The analytics component may be one that is utilized to process, determine, and/or visualize this data as it relates to particular transactions (e.g., business transactions) and/or to particular sequences of transactions (e.g., business journeys).

The secure application component may be a component focused specifically on the security aspects of application performance management. It may operate to assess the security posture of applications, identify vulnerabilities, monitor for security threats in real-time, and/or provide risk scores for transactions. A secure application component may be concerned with the integrity and confidentiality of data within the application, as well as compliance with security policies and standards.

Prioritized risk mitigation operations may be executed utilizing data exchanges between an analytics component frontend (e.g., analytics component user interface 502), events component backend service 504, secure application component backend service 506, and/or secure application component user interface 508 of architecture 500. For example, analytics component user interface 502 may, at box 510, fetch a configuration for a journey from events component backend service 504. This operation may be premised on an identification of the particular relevant sequence of transactions (e.g., the journey) that a user wishes to analyze. For example, analytics component user interface 502 may be utilized to provide a key or identifier (e.g., input by a user, identified based on a user interaction with the analytics component user interface 502, etc.) for the sequence of transactions to the events component backend service 504 as part of a configuration retrieval request.

Events component backend service 504 may utilize this identifier to generate and/or fetch the corresponding sequence of transaction's configuration data. The configuration data may include a definition of the sequence of transactions including its constituent transactions and/or milestones. This configuration may include details regarding the order of the transactions and/or various observability data associated with its monitoring of those transactions and/or the overall sequence of transactions. In addition, the configuration may specify the transaction keys or identifiers for each of the transactions that constitute the milestones of the identified sequence of transactions. Events component backend service 504 may, at box 512, send the configuration data to analytics component user interface 502.

Upon receipt, analytics component user interface 502 may utilize the configuration data received from events component backend service 504 to render a visualization of the sequence of transactions and/or its constituent milestone transactions. In addition, analytics component user interface 502 may, at box 514, send all or a portion of the configuration data received from events component backend service 504 to secure application component backend service 506. For example, analytics component user interface 502 may send the journey identifier and/or transaction identifiers to events component backend service 504 as part of a request for risk assessments for the identified journey and/or each of its constituent milestone transactions.

Secure application component backend service 506 may utilize this configuration data to generate security risk assessments for the overall sequence of transactions and/or for each of its constituent milestone transactions. For example, secure application component backend service 506 may have precalculated individual risk assessment scores for each of the transactions or milestones that it is monitoring based on the data it has collected and/or accessed regarding each of them. Secure application component backend service 506 may, therefore, utilize the milestone transaction identifiers it received as part of the configuration data to identify and/or retrieve their corresponding individual risk assessment scores. Then, secure application component backend service 506 may perform an overall security assessment (e.g., calculate an overall risk assessment score) for the identified sequence of transactions based on the individual risk assessment scores of each of its identified constituent milestone transactions.

A risk assessment (e.g., individual and/or overall) may be based on a risk likelihood and/or an application-based impact (e.g., business impact) of the individual transactions and/or the overall sequence of transactions. For instance, a risk assessment score may be calculated based on risk likelihood contributing factors such as vulnerable libraries, threat events, application environment, etc. of the identified individual transactions and/or the overall identified sequence of transactions.

Further, a risk assessment score may be calculated based on application-based impact contributing factors such as a configuration of a transaction(s), a load of a transaction(s), a priority (e.g., input or calculated) of a transaction(s) to a user, data access associated with a transaction(s), etc. for the identified individual transactions and/or the overall identified sequence of transactions. Furthermore, in various implementations the application-based impact component of the risk assessment score may include an additional weighted parameter that is based on an individual transaction being involved in the identified sequence of transactions.

This additional weighted parameter may be utilized to indicate that a particular transaction is of priority to a user as it has been identified as being included in the identified sequence of transactions. Consequently, this weighted parameter may enable a risk assessment score to consider the overall journey and enable prioritization of particular transactions involved in that journey such that that a user is presented with the relevant transactions that truly matters to that user in their analysis of that particular journey. Again, a secure application component may be monitoring and/or providing data on hundreds or even thousands of transactions. Therefore, including this weighted parameter, which can be utilized to identify and/or boost only those transactions being monitored by the secure application platform that are relevant to analysis of a particular complex process of interest within which they are participating transactions, can significantly streamline journey analysis and transform risk mitigation prioritization.

At box 516, secure application component backend service 506 may return the results of its risk assessment to the analytics component user interface 502. That is, secure application component backend service 506 may deliver an individual risk assessment score calculated for each of the identified transaction milestones and/or an overall risk assessment score calculated for the overall identified journey to analytics component user interface 502. Analytics component user interface 502 may utilize this data to render a graphical representation (e.g., graphical representation 600 of FIG. 6) of the identified journey's configuration. This graphical representation may incorporate text, graphics, colors, etc. that express the configuration of the journey, the transaction milestones, observability/performance data associated with the journey and/or its constituent transactions, overall risk assessment results for the journey, individual risk assessment results for each of the transactions of the journey, etc. In various implementations, the graphical representation may display the overall and individual risk assessment scores utilizing color-coded, pattern-coded, graphic-coded, etc. risk indicators.

Ultimately, users may interact with the graphical representation presented by analytics component user interface 502. Examples of an interaction may include moving a cursor over elements of the graphical representation.

In examples where the cursor is moved to hover over a portion of the graphical representation that represents a particular transaction milestone, a popup, bubble, icon, etc. may be overlaid on the graphical representation which provides more specific risk assessment results (e.g., a risk assessment score, a risk assessment level color indicator, a risk assessment level text indicator, etc.) for that transaction milestone.

In further examples, the user interaction may include a selection (e.g., a click) of the portion of the graphical representation. This may include a selection of a portion that represents a particular transaction milestone and/or a selection of a portion of the graphical representation that represents overall data about the sequence of transactions such as the overall risk assessment results (e.g., the overall risk assessment score, the overall risk assessment level color indicator, the overall risk assessment level text indicator, etc.) for the journey.

At box 518, analytics component user interface 502 may launch a secure application component (e.g., secure application component user interface 508) to conduct risk analysis and risk mitigation operations. Specifically, the secure application component may be launched responsive to the above-outlined user interaction. This operation may include causing a prioritization of risk mitigation candidate transactions featured by the secure application component. As previously mentioned, a secure application component may be charged with monitoring and mitigating risk across many transactions and/or many different journeys. As such, simply launching the secure application component may result in the user being presented with a voluminous listing of the many transactions being handled by the platform. This may not be of much use to the user and may ultimately obfuscate transactions of interest leading to risk misidentification and/or misallocation of mitigatory efforts and resources.

Instead, analytics component user interface 502 may cause risk mitigation candidate transactions to be prioritized for presentation to the user and/or for mitigation action. This prioritization may be based on the overall risk assessment results for a particular identified sequence of transactions and/or based on the individual risk assessment results for each individual transaction of the particular identified sequence of transactions. For instance, a listing of risk mitigation candidate transactions presented by the secure application component user interface 508 may be prioritized based on the overall and/or individual risk assessment results to prioritize the transactions of a particular sequence of transactions being analyzed by the user (e.g., the journey indicated by the user interaction to the graphical user interface) over those transactions monitored by the secure application platform that are not part of the particular sequence of transactions being analyzed. Prioritizing the risk mitigation candidates may include filtering a listing of risk mitigation candidate transactions presented by the secure application component user interface 508 based on the overall and/or individual risk assessment results so that only those transactions involved in the identified journey are presented.

In some implementations, a user may land on secure application component user interface 508 and be presented with a list of transactions being monitored. Then, secure application component user interface 508 may place a call to the analytics component backend API to determine whether a given transaction is part of a particular sequence of transactions. If it finds a positive match, it may cause the listing of the transaction within the list to be annotated as part of the particular journey. This may facilitate automated and/or user-directed selection of all the transactions that are part of a particular journey and their prioritization for mitigation operations.

FIG. 6 illustrates an example of a graphical representation 600 that may be rendered by an analytics component through prioritized risk mitigation in transaction sequences. Graphical representation 600 may include a risk-modified rendering of an identified transaction sequence's (e.g., journey) configuration.

For example, graphical representation 600 may illustrate each of the transaction milestones 602 (e.g., 602-1 . . . 602-N) for the identified journey. In addition, graphical representation 600 may include a label associated with each of the transaction milestones 602, an amount of instances or load for each of the transaction milestones 602, an amount of time elapsed between each of the transaction milestones 602 during execution, etc. Each of the transaction milestones 602 may also be color-coded, pattern-coded, graphic-coded, etc. with an indication of their risk assessment results. For example, a color or pattern around each of the transaction milestones 602 could indicate a risk assessment score for that particular milestone.

When a user hovers over a portion of the graphical representation that represents a particular transaction milestone (e.g., first transaction milestone 602-1), an information overlay 604 may be overlaid on the graphical representation 600. The information overlay 604 may include more specific risk assessment results (e.g., an individual risk assessment score for the transaction, a risk assessment pattern or color indicator associated with the transaction, a risk assessment level text indicator such as “Warning” for the transaction, etc.) for that transaction milestone.

In various implementations, the graphical representation 600 may include overall data about the journey. This may include an end-to-end time for the journey, a conversion rate for the journey, and/or an overall risk assessment score 606 for the journey (e.g., on a left bar of the graphical representation 600, a risk score for the entire journey is shown, etc.).

A user interaction with graphical representation 600, such as a selection of the overall risk assessment score 606 or other portion of graphical representation 600, may trigger a launch of a secure application component and/or a prioritization of risk mitigation candidate transactions from among the transactions managed by the secure application component. For instance, a list of the transactions managed by the secure application platform may be filtered to only those transaction milestones 602 within the journey being analyzed via graphical representation 600.

In closing, FIG. 7 illustrates an example simplified procedure for prioritized risk mitigation in transaction sequences in accordance with one or more implementations described herein. For example, a non-generic, specifically configured device (e.g., device 200) may perform procedure 700 by executing stored instructions (e.g., mitigation prioritization process 248).

The procedure 700 may start at step 705, and continues to step 710, where, as described in greater detail above, a device may identify a sequence of transactional milestones performed by users within an online application. The transactional milestones may be events or milestones associated with the execution of a process of the online application executed across distributed services. The sequence of transactions may be a journey including a series of transactions making up a complex process end-to-end.

The journey may be a tracked and/or visualizable unit defined by the series of related transactions making up a complete workflow or process of the online application within an application performance management platform. For example, the journey may be a component of an application performance management platform that is configured to give application administrators insights into how related groups of transactions, which represent a user or system journey through an application or series of applications, perform and affect the overall outcomes.

For instance, a virtual medical appointment journey might include transactions spanning a user requesting an appointment, engaging in patient data verification, engaging in physician assignment and scheduling, receiving pre-consultation preparation, and participating in appointment confirmation and the virtual visit. Each of these steps would be individual transactions that, when linked together, create the entire journey of a user from start to finish. Application performance management platform monitoring of these journeys may be configured to facilitate identification of critical paths or transaction sequences that are most impactful, understanding the user experience and performance for key workflows, detecting where bottlenecks or issues occur within complex processes, prioritizing fixes and improvements based on the impact, etc.

Obtaining a configuration of the sequence of transactions of the online application may involve identifying the sequence of transactions based on an identifier of the sequence. In addition, each transaction of the sequence of transactions may be identified based on a common key shared by those transactions and utilized by the application performance management platform to monitor the sequence of transactions.

At step 715, the device may determine individual risk assessments for each transactional milestone. This determination may be based in part on any vulnerabilities associated with the code used to perform the transactional milestones.

The individual risk assessments for each transaction may be based on an application-based impact associated with a corresponding transaction. For example, the application-based impact may be calculated based on a weighted parameter indicative of a priority of the corresponding transaction to a user, the configuration of the corresponding transaction, and/or a level of interaction with a database associated with the corresponding transaction.

Additionally, or alternatively, the individual risk assessments for each transaction are based on a threat likelihood associated with a corresponding transaction, the threat likelihood may be calculated based on a vulnerable library presence, a threat event, and/or an application environment associated with the corresponding transaction.

At step 720, the device may determine, based on the individual risk assessments, an overall risk assessment for the sequence of transactional milestones. In some instances, the individual risk assessments and/or the overall risk assessment may be determined based on a configuration. For example, the configuration may include identifiers of each transaction in the sequence of transactions and these identifiers as well as an identifier of the sequence of transactions. These identifiers may be utilized to formulate risk individual assessments for each of the transactions as well as the overall risk assessment for the sequence of transactions.

In various implementations, the individual risk assessments and the overall risk assessment may be determined by providing the identifiers of each transaction in the sequence of transactions to a backend security risk assessment calculation service. The individual risk assessments and the overall risk assessment may include a numeric risk score representative of a risk or threat level associated with that transaction and/or the sequence of transactions.

At step 725, the device may provide a representation of the sequence of transactional milestones. The representation may include indications of the individual risk assessments and the overall risk assessment for the sequence of transactional milestones for display by a user interface.

The representation may be a graphical representation that includes indications of the individual risk assessments of the transactional milestones in the representation. Each of the indications of the individual risk assessments in the representation may correspond to different levels of application-based impact associated with execution of a corresponding transactional milestone. The application-based impact may be calculated based on a weighted parameter indicative of a priority of the corresponding transactional milestone to a user, a configuration of the corresponding transactional milestone, and/or a level of interaction with a database associated with the corresponding transactional milestone.

For example, the representation may be a graphical representation that may include an individual risk assessment indicator such as a color-coded representation of the individual risk assessments for each transaction (e.g., a respective colored ring associated with each transaction). That is, the individual risk assessments for each transactional milestone may be color-coded to a corresponding threat level determined by the risk assessment. Additionally, or alternatively, the indicator of the individual risk assessment may be a numerical score.

The graphical representation may be interactive, such that a user may interact with it by selecting or clicking portions of it, hovering over portions of it, etc. to instigate various actions. In various implementations, a selection of a portion of the representation may be received at the device via the user interface. For example, a selection of a particular transactional milestone and/or a portion of the graphical representation representing an overall risk assessment of the sequence of transactions depicted in the representation may be received thereby triggering a launching of a prioritized list of risk mitigation candidate transactions.

Responsive to receiving such a selection, the device may provide a listing of one or more vulnerabilities associated with the particular transactional milestone for display by the user interface. Providing the listing may include providing a prioritized list of transactional milestones. For instance, a listing may be provided that prioritizes vulnerabilities associated with transactional milestones in the sequence of transactional milestones over vulnerabilities associated with transactional milestones in other sequences of transactional milestones. That is, the prioritization of the risk mitigation candidate transactions may include filtering a list of risk mitigation candidate transactions (and/or their associated vulnerabilities) to prioritize transactions (and/or their associated vulnerabilities) in the sequence of transactions over transactions (and/or their associated vulnerabilities) in the list that are not in the sequence of transactions.

In some instances, the prioritization in the listing may be a function of the transactions associated risk assessments. For example, a listing of the vulnerabilities may be sorted based on their corresponding individual risk assessment. In such instances, an individual risk assessment for a particular transactional milestone may be modified to prioritize the particular transactional milestone based on the overall risk assessment for the sequence of transactional milestones.

In various implementations, providing the listing of vulnerabilities may include prioritizing vulnerabilities with annotations. For example, providing the listing of vulnerabilities may include annotating vulnerabilities associated with transactional milestones in the sequence of transactional milestones within the listing. This may provide an annotation-based prioritization of those vulnerabilities within a listing that includes other vulnerabilities that are associated with transactional milestones in other sequences of transactional milestones.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, provide for risk mitigation candidate prioritization that provides and leverages end-to-end process context to facilitate actionable risk assessment. The outlined risk mitigation candidate prioritization approach may facilitate an automated or user-based approach to quickly addressing the most important processes and mitigation of threats thereto. Further, this approach may facilitate automated and/or user-instigated addressment of the security needs of critical processes with a higher priority such as by prioritizing the relevant transactions within the listing according to their contribution to the overall risk assessment for the identified journey. As such, the risk assessments may incorporate the journey configuration into the secure application platform analytical and/or mitigatory operations, providing a more actionable and contextualized risk identification and mitigation approach.

These techniques enhance the field of application performance management by, among other things, enhancing the ability to visualize, analyze, and prioritize risks associated with business transactions in real time. For example, these techniques integrate transaction risk assessments with process milestones within the user interface, facilitating a more nuanced and actionable representation of risk. This enables users and automation to not only monitor but also effectively prioritize risk mitigation efforts based on the composite risk profile of a business journey.

This technical advance addresses the deficiencies in prior systems that treated all transactions uniformly without considering their relative importance or impact on the end-to-end journey. By intelligently integrating risk assessment and prioritization within the operational flow, these techniques significantly enhance the efficiency of risk management processes, minimizes potential disruptions, and optimizes resource allocation for risk mitigation actions. These enhancements contribute to the reliability and security of critical applications, squarely addressing the practical applications of technology in the realm of digital communications.

While there have been shown and described illustrative implementations that provide for risk mitigation candidate prioritization, it is to be understood that various other adaptations and modifications may be made within the spirit and scope of the implementations herein. For example, while certain implementations are described herein with respect to using certain risk assessment techniques, graphical representation features, types of transactions, etc. the disclosed techniques are not limited as such and may include other risk assessment techniques, graphical representation features, types of transactions, etc., in other implementations.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, a sequence of transactional milestones performed by users within an online application;
determining, by the device, individual risk assessments for each transactional milestone, based in part on any vulnerabilities associated with code used to perform those transactional milestones;
determining, by the device and based on the individual risk assessments, an overall risk assessment for the sequence of transactional milestones; and
providing, by the device, a representation of the sequence of transactional milestones with indications of the individual risk assessments and the overall risk assessment for the sequence of transactional milestones for display by a user interface.

2. The method as in claim 1, further comprising:
receiving, at the device and via the user interface, a selection of a particular transactional milestone depicted in the representation; and
providing, by the device and in response to receiving the selection, a listing of one or more vulnerabilities associated with the particular transactional milestone for display by the user interface.

3. The method as in claim 1, wherein the indications of the individual risk assessments in the representation correspond to different levels of application-based impact associated with execution of a corresponding transactional milestone.

4. The method as in claim 3, wherein the application-based impact is calculated based on one or more of:
a weighted parameter indicative of a priority of the corresponding transactional milestone to a user;
a configuration of the corresponding transactional milestone; or
a level of interaction with a database associated with the corresponding transactional milestone.

5. The method as in claim 1, wherein an individual risk assessment for a particular transactional milestone is modified to prioritize the particular transactional milestone based on the overall risk assessment for the sequence of transactional milestones.

6. The method as in claim 1, further comprising:
providing a list of transactional milestones that prioritizes transactional milestones in the sequence of transactional milestones over transactional milestones in other sequences of transactional milestones.

7. The method as in claim 1, further comprising:
annotating transactional milestones in the sequence of transactional milestones within a listing including transactional milestones in other sequences of transactional milestones.

8. The method as in claim 1, wherein the individual risk assessments for each transactional milestone are color-coded to a corresponding threat level.

9. The method as in claim 1, wherein the individual risk assessments for each transactional milestone are based on a threat likelihood associated with a corresponding transactional milestone.

10. The method as in claim 9, wherein the threat likelihood is calculated based on one or more of:
a vulnerable library presence;
a threat event; or
an application environment associated with the corresponding transactional milestone.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
identify a sequence of transactional milestones performed by users within an online application;
determine individual risk assessments for each transactional milestone, based in part on any vulnerabilities associated with code used to perform those transactional milestones;
determine, based on the individual risk assessments, an overall risk assessment for the sequence of transactional milestones; and
provide a representation of the sequence of transactional milestones with indications of the individual risk assessments and the overall risk assessment for the sequence of transactional milestones for display by a user interface.

12. The apparatus as in claim 11, the process further executable to:
receive, via the user interface, a selection of a particular transactional milestone depicted in the representation; and
provide, in response to receiving the selection, a listing of one or more vulnerabilities associated with the particular transactional milestone for display by the user interface.

13. The apparatus as in claim 11, wherein the indications of the individual risk assessments in the representation correspond to different levels of application-based impact associated with execution of a corresponding transactional milestone.

14. The apparatus as in claim 13, wherein the application-based impact is calculated based on one or more of:
a weighted parameter indicative of a priority of the corresponding transactional milestone to a user;
a configuration of the corresponding transactional milestone; or
a level of interaction with a database associated with the corresponding transactional milestone.

15. The apparatus as in claim 11, the process further executable to:
provide a list of transactional milestones that prioritizes transactional milestones in the sequence of transactional milestones over transactional milestones in other sequences of transactional milestones.

16. The apparatus as in claim 11, the process further executable to:
annotate transactional milestones in the sequence of transactional milestones within a listing including transactional milestones in other sequences of transactional milestones.

17. The apparatus as in claim 11, wherein the individual risk assessments for each transactional milestone are color-coded to a corresponding threat level.

18. The apparatus as in claim 11, wherein the individual risk assessments for each transactional milestone are based on a threat likelihood associated with a corresponding transactional milestone.

19. The apparatus as in claim 18, wherein the threat likelihood is calculated based on one or more of:
a vulnerable library presence;
a threat event; or
in an application environment associated with the corresponding transactional milestone.

20. A tangible, non-transitory, computer-readable medium storing program instructions that cause a device to execute a process comprising:
identifying a sequence of transactional milestones performed by users within an online application;
determining individual risk assessments for each transactional milestone, based in part on any vulnerabilities associated with code used to perform those transactional milestones;
determining, based on the individual risk assessments, an overall risk assessment for the sequence of transactional milestones; and
providing a representation of the sequence of transactional milestones with indications of the individual risk assessments and the overall risk assessment for the sequence of transactional milestones for display by a user interface.
